(19) United States
(12) Patent Application Publication
(10) Pub. No.: US 2026/0099979 A1
(43) Pub. Date: Apr. 9, 2026

(54) CONTROLLED AI SEAMLESS TALKING AVATARS APPLICATION CREATION WITH A NATURAL LANGUAGE COMMANDS

(71) Applicant: 2hr Learning, Inc., Austin, TX (US)

(72) Inventors: Andrew Wiskus, Venice, CA (US); Andy Montgomery, Austin, TX (US); Guiherme Pacheco, Venice, CA (US)

(73) Assignee: 2hr Learning, Inc., Austin, TX (US)

(21) Appl. No.: 19/352,290

(22) Filed: Oct. 7, 2025

Related U.S. Application Data
(60) Provisional application No. 63/704,437, filed on Oct. 7, 2024.

(51) Int. Cl. G06T 13/40; G06F 8/35; G06F 11/3668; G06F 40/205

(52) U.S. Cl. CPC G06T 13/40; G06F 8/35; G06F 11/3688; G06F 40/205

(57) ABSTRACT

A talking avatar generation system and method featuring one or more avatars, using natural language inputs received from the user to guide an artificial intelligence (AI) engine in generating talking avatar applications using natural language input from a user is disclosed. The method involves receiving a natural language input or prompt from the user which is then analyzed and parsed to convert it into a structured API request with commands and parameters. Using these commands, the application code is generated that integrates interactive avatars with the functionalities specified by the user. The avatar's personalities are created using prompt engineering techniques, enabling them to display distinct behaviors, emotions, and conversational traits. The generated code undergoes automated testing in a simulated environment to ensure reliability. Finally, the talking avatar application is deployed and displayed to the user, allowing real-time communication with the avatars.

### CROSS-REFERENCE TO RELATED APPLICATION(S)

This application claims the benefit under 35 U.S.C. § 119 (e) and 37 C.F.R. § 1.78 of U.S. Provisional Application No. 63/704,437, which is incorporated by reference in its entirety.

### FIELD OF THE INVENTION

The present invention relates in general to the field of electronics, and more specifically to a system of generation of a talking avatar application featuring an avatar that interacts with the user in real-time. The application is generated using the natural language input provided by the user.

### BACKGROUND OF THE INVENTION

The development of custom applications has been a domain reserved for those with significant technical expertise, particularly in programming languages and software development frameworks. Manual coding has been the basis of this process, necessitating that developers precisely write, test, and debug lines of code to create functional applications. This approach, while effective for experienced programmers, has posed a considerable barrier for non-programmers who lack the necessary skills to engage in such a technically demanding task. As a result, many individuals and small businesses without access to specialized talent have found themselves unable to create custom applications tailored to their specific needs, thereby limiting innovation and the diversity of ideas that could potentially enrich various industries.

Application development tools have also been complex, often requiring not just programming knowledge but also familiarity with specialized software environments and tools. This complexity creates a steep learning curve, keeping out those who might have great ideas but lack the technical skills to bring them to life. As a result, the opportunity for widespread innovation is reduced, as the creation of custom applications remains in the hands of a select few who possess the necessary technical expertise.

In addition to these challenges, traditional methods of app development are often rigid, forcing developers to work within predefined frameworks and programming languages. This rigidity can limit creativity, as developers must adjust their ideas to fit within the constraints of the tools they are using. This lack of flexibility can prevent the creation of solutions that perfectly match the developer's vision.

The traditional software development process, which involves writing, testing, and debugging code, can be slow and inefficient. In industries where speed and adaptability are crucial, these delays can be a significant drawback. Businesses that can't quickly update or create new applications may fall behind their competitors, highlighting the need for faster and more efficient development processes.

Lastly, while Application Programming Interfaces (APIs) are vital for connecting different software components, they are often complicated and require a deep understanding of technology to use effectively. For those without technical expertise, this complexity can be a major obstacle, further limiting their ability to create custom applications.

### BRIEF DESCRIPTION OF THE DRAWINGS

The systems and methods described herein may be better understood, and their numerous objects, features, and advantages are made apparent to those skilled in the art by referencing exemplary embodiments depicted in the accompanying figures. The use of the same reference number throughout the several figures designates a like or similar element.

FIG. 1 depicts an exemplary talking avatar application generation system featuring one or more interactive avatars, using a natural language input.

FIG. 2 depicts an exemplary talking avatar application generation process featuring one or more interactive avatars, using a natural language input.

FIG. 3 depicts an application testing and deploying process by utilizing user inputs, which is an embodiment of the talking avatar application generation process featuring one or more interactive avatars, using a natural language input.

FIG. 4 depicts an exemplary generated application displaying a talking avatar.

FIG. 5 depicts an AI engine where the user provides the natural language input, to guide the AI engine to generate an application code for the generation of a tracking avatar application.

FIGS. 6 and 7 depict exemplary AI engine screenshots where the generated application code and the basic explanation of the application code are shown respectively.

FIG. 8 depicts the exemplary generated talking avatar application featuring an avatar, based on the natural language input provided by the user.

FIG. 9 depicts an exemplary generated talking avatar application that shows two different avatars doing debate and providing their views on a topic.

FIGS. 10 and 11 depict exemplary different gaming applications generated by utilizing the talking avatar application generation system featuring one or more interactive avatars.

FIG. 12 depicts a data structure for organizing data to disclose the use of natural language input to generate a talking avatar application.

FIG. 13 depicts an exemplary network environment in which the system of FIG. 1 and the process of FIG. 2 may be practiced.

FIG. 14 depicts an exemplary computer system.

### DETAILED DESCRIPTION

An interactive, talking avatar application generation system featuring one or more interactive avatars, using natural language inputs to guide the artificial intelligence (AI) engine to create a talking avatar application. The system and method allow users to generate dynamic, interactive avatars that can engage in real-time communication with users, displaying a range of emotions and expressions by using natural language processing. Using AI-powered application programming interfaces (API's) that enable natural language interaction for custom application creation provides technology improve a computer system to significantly enhance accessibility, reduce a learning curve, and accelerate the development process, making it a superior solution for a wide range of users. The system and method herein is, for example, utilized in environments where there is a need to streamline and democratize the creation of interactive solutions through natural language interactions. This technology is particularly beneficial in scenarios where users may lack traditional programming skills but wish to create custom solutions with interactive and conversational avatars or where rapid prototyping of such solutions is desired. The technical advantages that improve a computer system to include:
The system's ability to transform natural language into a functional interactive avatar solution, providing significant value by making the creation of advanced, interactive avatar technologies accessible to a broader audience.
Enhanced Accessibility: By allowing natural language inputs to direct the creation of applications, the system and method make application development available to a broader audience, including those without formal programming training. This democratization of technology can lead to more diverse and innovative applications.
Increased Efficiency: The AI-powered approach can significantly speed up the development process by automating coding tasks based on user commands. This efficiency not only accelerates the development cycle but also reduces the potential for human error.
Flexibility and Creativity: Users can specify features and functionalities in their own words, allowing for more creative and tailored application development. This flexibility can lead to the creation of unique applications that might not have been feasible with traditional coding methods.
Example: A scenario where a teacher wants to create an educational game to help students learn physics. Using the AI-powered API, the teacher could simply describe the game's rules and objectives in natural language, and the API would generate the necessary code. This process could include creating an interactive game where students solve physics problems with the help of an interactive avatar, like Albert Einstein, and navigate through challenges, making learning both engaging and effective.

This system and method not only simplify the application development process but also make technology more accessible and adaptable, representing a significant leap over traditional methods. The creation of solutions that use interactive avatars allows the users to create interactive and conversational solutions in different scenarios, which suit different needs of different kinds of users and businesses. The use of AI to translate natural language into functional applications is a novel approach that leverages recent advancements in AI and machine learning, particularly in natural language processing and automated code generation. This innovation is poised to transform how applications are created, making technology creation more inclusive and responsive to user needs.

In at least one embodiment, the talking avatar application generation system includes an interface, such as a chatbot, a prompt generator, and an AI engine. The user provides input data for integration into an engineered prompt to guide and constrain the AI engine. The AI engine is guided in at least two processes to generate an avatar that is reactive to user input. The first process provides a file to the AI engine to instruct the AI engine with a machine learning model to use an avatar AI programming interface to create an avatar using a natural language input from a user. The second processes The user input data can be entered, for example, in natural language or through other methods such as other freeform text entries, structured text entries, or selections, via an application programming interface (API) or the chatbot. An The input data is passed to an analyzer to analyze the data and generate insights which are further used by an AI engine to generate application code to create. The code generator utilizes AI NLP (Artificial Intelligence Natural Language Processing) techniques to generate the application code. The application code generated by the code generator is, for example, React Code.

The generated application code is then passed on to a code tester which is operatively coupled to the code generator. The code generator tests for the errors and bugs in the application code before the final generation of the talking avatar application. Subsequently, an avatar generator of an AI engine is enabled to generate the avatars based on the details provided by the user in the natural language input.

Finally, the talking avatar application is generated featuring one or more avatars and is deployed in the user-friendly environment. The user can access the talking avatar application and interact with the avatar. Further, if the user wishes to make any changes in the application, then the user can give the prompt to the AI engine via., the chatbot to make the necessary changes. The AI engine will analyze the prompt and make the necessary changes.

The talking avatar application generation system offers significant advantages by enabling non-technical users to create complex, interactive applications, such as talking avatars, using natural language input. This reduces the need for coding expertise, making advanced technology accessible to a broader audience. The ability of the talking avatar application generation system to interpret user input, generate accurate application code, and automatically test and deploy applications cases the application development process, saving time and resources. Additionally, the support for multi-language capabilities and real-time interaction enhances the versatility and personalization of the applications, allowing users to generate applications to their specific needs across various domains like customer support, education, gaming, and business.

The system and method set forth herein address technical issues with generating the desired outputs described herein. Conventionally, manual processes were used to generate the desired outputs and were very tedious and time consuming. The present system and method utilize an automated system that does not merely automate a manual process or use a conventional system in a conventional way. The present system and method utilize one or more artificial intelligence (AI) engines and integrate programmatic process management to technologically guide and constrain the one or more AI engines to produce the desired outputs in a completely different way than any manual process and different than normal use of programs and AI engines. Utilizing specially engineered guidance and control to direct an AI system to solve the problems below presents a technical problem that requires a technical solution. The system and method described below are not simply engaging a computer to carry out conventional mental processes, but rather change how computers (and AI systems, specifically) operate to achieve the generation results that were not previously possible or were substantially inefficient prior to the system and method set forth below. The AI system needs specific technical guidance, control, and constraints to achieve results that are not otherwise achievable.

Prompts are used to guide and constrain each AI engine. The prompts guide each AI engine by steering the AI engine(s). “Guiding” an AI engine refers to providing the AI engine with a general direction or framework to shape the AI engine's behavior or decision-making process. Guiding sets goals or principles. Guiding allows the AI engine some flexibility to interpret and adapt, much like giving it a compass to navigate rather than a fixed path.

Constraining each AI engine includes imposing specific, hard limits or rules on what each AI engine can do. Constraining an AI engine can also include providing specific input data to not only guide but also constrain the scope of each AI engine's reasoning basis and response. Constraining each AI engine assists with aligning the AI engine(s) for its (their) intended use.

Normally AI engines are provided a single user prompt requesting the AI engine, such as OpenAI's ChatGPT and its various implementations such as Anthropic's Claude Sonnet, to perform a task and produce an output. However, this conventional AI engine prompting method has a variety of technical shortcomings. Without proper guidance and constraints, an AI engine will not produce the desired output specified as produced by the system and method described herein. Instead, the AI engine will produce many unusable outputs that are unusable for a variety of reasons including so-called “hallucinations” where the AI engine presents fabricated information, duplicate outputs, too few outputs, too many outputs, outputs that do not meet desired criteria, and so on. Without special technical guidance, the AI engine cannot reliably be applied to generate desired outcomes.

The system and method generate decomposed, technically engineered AI prompts to include selected and integral AI engine guidance and constraints. Conventional approaches often do not recognize the technical capabilities of an engineered prompt to guide and constrain an AI engine to generate a desired output. The technically engineered prompts are generated and guided with programmatic, automatic inputs specifically designed to unconventionally guide and constrain an AI engine to produce desired outputs, perform quality control to retain or automatically discard outputs that do not meet guidance and constraints, and make the desired outputs available for use, such as use by computer system applications. In at least one embodiment, the problem to be solved by the integrated programmatic and AI engine system and method is uniquely and unconventionally decomposed, and AI prompts are used to solve the decomposed problem. Furthermore, the programmatic inputs to the decomposed AI prompts provide guidance to meet desired output characteristics.

Determining a number of prompts, the guidance and constraints within each prompt, and data flowing from one AI engine prompt to another, in addition to testing a number of prompts for the decomposed problem, testing within each prompt, and validating a desired quality of outputs becomes an intractable combinatorial problem without technical guidance and constraint of the system and method described herein. Thus, the present system and method described implement an integration of programmatic management over decomposed prompts with engineered AI engine guidance and constraints to effect an improvement in AI, programmatic AI management, and AI integrated with programmatic management technology. The present system and method allow computer systems to include programmatic management, one or more AI engines, and one or more data sources to produce the output described herein that previously could not be produced with conventionally prompted AI engines or could only be produced by humans utilizing a completely different, time consuming, and tedious process. The system and method improve conventional methods through the use of a programmatic AI engine management system to generate decomposed, technically engineered AI prompts to include selected and integral AI engine guidance and constraints. It is, for example, the incorporation of the programmatic AI engine management system to generate decomposed, technically engineered AI prompts to include generated, integral, and unconventional AI engine guidance and constraints and execution by the one or more AI engines to provide useful results that improve existing technical processes, which is not an automation of a conventional process.

Programmatic components and AI engines generally utilize one or more processors that have access to memory, which may include one or more storage components, to execute and perform functions. An AI engine is a core hardware and software system that enables artificial intelligence applications to process data, learn patterns, and generate insights or actions. It functions as the brain behind AI-driven systems, facilitating tasks such as machine learning, natural language processing, and decision-making. Exemplary components of an AI engine are:
1. Machine Learning Models-Algorithms that analyze data, recognize patterns, and make predictions.
2. Neural Networks-Deep learning architectures that mimic the human brain for tasks like image and speech recognition.
3. Data Processing Module-Handles raw data input, transformation, and feature extraction.
4. Inference Engine-Applies trained models to make real-time decisions based on new data.
5. Optimization Algorithms-Improves model efficiency, reducing errors and improving predictions.
6. Natural Language Processing (NLP) Module-Enables AI engines to understand, interpret, and generate human language (e.g., chatbots, voice assistants).
7. Computer Vision Module-Allows AI to interpret and analyze images or videos.
8. Reinforcement Learning Mechanism-Helps AI learn from trial and error, optimizing performance over time.
9. API Interface-Connects the AI engine with applications, enabling integration with other software or platforms.

Examples of AI Engines include: XAI's Grok and variations thereof, Google TensorFlow, Meta's PyTorch, Microsoft Azure AI, OpenAI's ChatGPT and variations thereof, IBM Watson, OpenAI Whisper, Google BERT & T5, Amazon Lex, Anthropic Claude, DeepMind's AlphaCode, Google Vision AI, Meta's DINO & SAM (Segment Anything Model), NVIDIA DeepStream. OpenCV AI Kit, Amazon Polly. Google WaveNet, Deepgram.

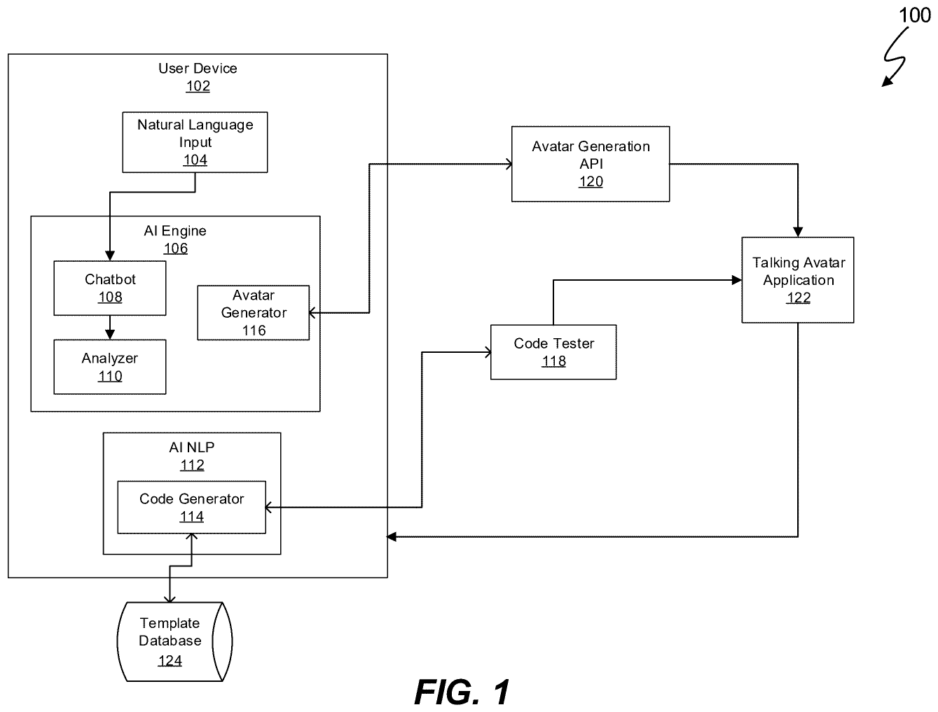

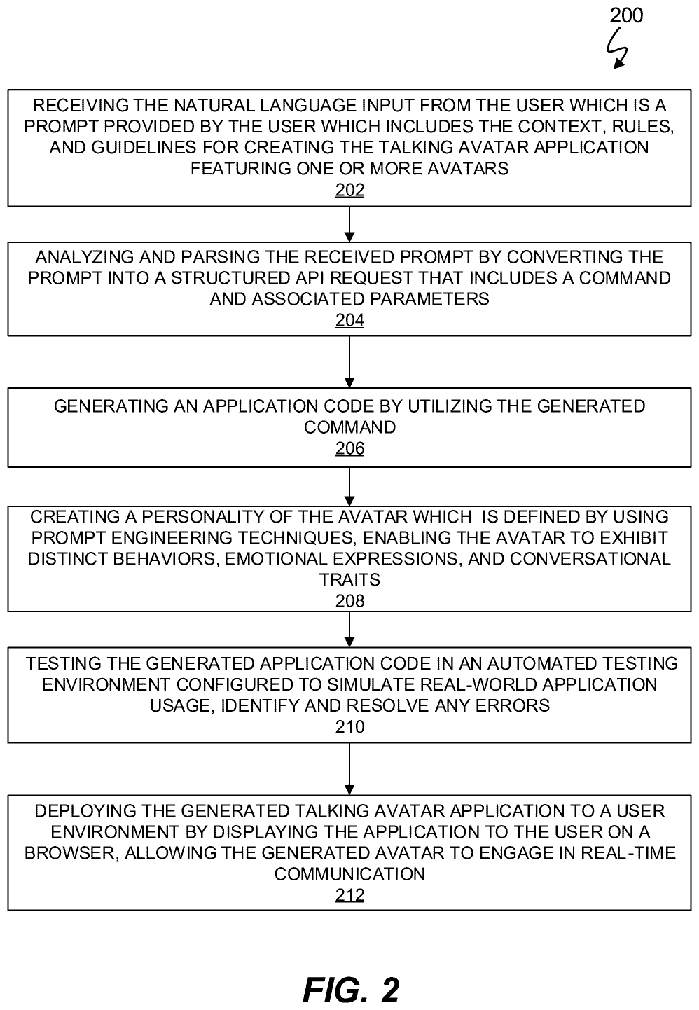

FIG. 1 depicts an exemplary talking avatar application generation system 100 featuring one or more interactive avatars, using a natural language input 104. FIG. 2 depicts an exemplary talking avatar application generation process 200 featuring one or more interactive avatars, using a natural language input 104, utilized by the talking avatar application generation system 100 featuring one or more interactive avatars, using a natural language input 104.

Referring to FIGS. 1 and 2, in operation 202, a chatbot 108 receives the natural language input 104 from the user. The natural language input 104 includes data that is programmatically added to an engineered prompt to enhance guidance and constraint of the AI engine 106. The data provided by the user includes, for example, context, rules, and guidelines for creating a talking avatar application 122 featuring one or more avatars.

In at least one embodiment, the chatbot 108 is integrated into the AI engine 106. The chatbot 108 serves as the interface for users to interact with the AI engine 106. When a user wants to create a talking avatar application 122, the user provides input data, such as natural language input, to the AI engine 106. In at least one embodiment, the input data is in the form of natural language that is interpreted by, for example, a chatbot 108. In at least one embodiment, the input data is structured data provided via an API (not shown). Assuming the input data is in a natural language form, the natural language input 104 is included in a prompt, which includes detailed context, rules, and guidelines that specify how the talking avatar application should be constructed. The context may include specific instructions about the avatar's appearance, behavior, emotions, and interactions. The rules and guidelines might outline constraints or preferences, such as the type of animations or the scenarios in which the avatar will be used.

The AI engine 106 is enhanced with sophisticated natural language processing (NLP) capabilities, takes the user's natural language input 104, and understands the user's context. The chatbot 108 then converts this natural language input 104 or prompt into a more structured format that the AI engine 106 can work with.

The natural language input 104 or prompt provided by the user is a Software Development Kit (SDK) code. This means that the input can be complex, containing specific programming instructions or configurations that direct how the AI 106 should function. The AI engine 106 uses this SDK code to generate the necessary application components, including the talking avatars, ensuring they align with the user's specifications. SDK code is a set of platform-specific tools that developers use to create code that runs on a specific operating system, programming language, or platform. Although not limited to SDK codes, the talking avatar application generation system 100 may also use other tools like Google Web Toolkit (GWT), Qt Toolkit, CMake, AWS Amplify, Firebase, and so on.

The chatbot 108 acts as a mediator between the user and the AI engine 106, transforming user-friendly natural language into technical instructions that guide the creation of the talking avatar application. This seamless interaction allows users, even those without programming knowledge, to design sophisticated applications through natural language input 104.

The exemplary natural language input 104 or prompt or the SDK code provided by the user to the AI engine 106 via., the chatbot 108 of the AI engine 106 is given below:

The above SDK code includes mainly three sections, namely, the boilerplate section, the jigsaw puzzle section, and the context section. The boilerplate is a piece of code that marks the beginning of the SDK code. These are the codes that are repeated multiple times in a SDK code with no to little variations. The jigsaw pieces are used by the AI engine 106 to define a custom solution for the operation of the avatar featured in the talking avatar application 122. For instance, the jigsaw pieces guide the AI engine 106 to show the avatar, mute/unmute the avatar whenever needed, and so on. The context section includes the rules, and guidelines, along with some examples that will guide the AI engine 106 in generating the personalized avatar. Also using the context in the SDK code, the behavior, emotions, and so on related to the avatar can be personalized by the user. For instance, based on the SDK code, the user can make changes in the speed, pitch, voice, and emotions of the avatar.

In operation 204, an analyzer 110 analyzes and parses the received natural language input 104 or the prompt. The analysis involves converting the prompt 104 into a structured API request that includes a command and associated parameters.

The analyzer 110 is integrated within the AI engine 106 and is configured to receive the natural language input 104 or prompt or SDK code from the chatbot 108 for further analysis.

When a user provides a natural language input 104 or prompt or SDK code to create a talking avatar application, the AI engine 106, which is based on a Large Language Model (LLM), processes the natural language input 104 or prompt or SDK code. The natural language input 104 or prompt or SDK code typically includes various specifications and guidelines for how the avatar should behave and interact. After analyzing the natural language input 104 or prompt or SDK code, the associated parameters are generated that define critical aspects of the avatar's functionality. These parameters include elements such as expression, behavior, lip-syncing, and eye movement, which collectively determine how the avatar will appear and act when featured in the talking avatar application. For instance, the expression parameter may include the avatar's facial expressions in response to different scenarios, while lip-syncing ensures that the avatar's mouth movements align with spoken dialogue.

The process of analyzing the prompt is handled by the LLM using advanced Natural Language Processing (NLP) techniques. Firstly, the AI engine 106 parses the natural language input 104 or prompt or SDK to break it down into understandable components, and interprets these components to identify the essential elements related to the avatar's behavior, emotions, and expressions. For example, if the user specifies that the avatar should appear happy when greeting someone, the AI engine 106 recognizes happiness as an emotional state and associates it with corresponding facial expressions and tone.

After identifying these key elements, the analyzer 110 extracts the relevant information from the natural language input 104 or prompt or SDK code to accurately determine the context. This means understanding not just what the user is asking for, but how those requests translate into specific, actionable commands.

Based on the understood context and the user's requirements, the analyzer 110 generates detailed insights which include avatar specifications. These specifications are comprehensive and include all the necessary details to guide the creation of the avatar, such as how it should move, respond to user interactions, and express emotions. These specifications are then used to feature the avatar within the talking avatar application 122, ensuring it behaves exactly as the user envisioned.

The AI engine 106 is trained on a vast array of diverse datasets. These datasets include programming languages, application logic, and various scenarios involving user interactions with avatars. The inclusion of programming languages in the training data allows the AI engine 106 to generate executable code based on the prompt. Application logic datasets help the AI engine 106 understand how different parts of the application should work together. Finally, datasets focused on user interaction with avatars enable the AI engine 106 to create avatars that can engage in meaningful, context-aware interactions with users.

As described in more detail, the code generator 114 enables generation of custom solutions to use an Avatar API by generating code using natural language. The structured API request generated by the analyzer 110 acts as an input for a code generator 114 that translates the user's natural language input 104 or prompt or SDK code into a precise, machine-readable format. This API request includes a set of parameters that define various avatar attributes, which are essential for creating a realistic and interactive avatar within the application. These attributes cover a wide range of characteristics that dictate how the avatar looks, moves, and behaves. For instance, the associated parameters include avatar attributes such as facial expressions, lip-syncing, eye movement, emotional states, and behavior patterns.

The exemplary SDK code provided by the user along with the natural language input 104 or prompt to the AI engine 106 is given below. The following “Instruction File” teaches the AI engine to use the avatar AI API with exemplary comments included:

In operation 206, the code generator 114 having been enabled by generation of the application code commands in operation 204 to integrate the interactive avatar and the associated functionalities specified by the user from a user NLP (Natural Language Processing) input based on the generated commands in the operation 204.

The code generator 114 is integrated within the AI engine 106 and receives the analyzed insights from the analyzer 110 in the form of a structured API request. The application code generated by the code generator 114 for creating the talking avatar application 122 is specifically produced in React, a popular JavaScript library used for application development, particularly for single-page applications where efficient, interactive components are essential. This choice of React code ensures that the talking avatar application 122 is highly responsive but also scalable and maintainable, making it easier for developers to integrate and modify the application as needed. Although the talking avatar generation system 100 is not only limited to using the React code for application development, other similar tools can also be used. For instance, React Native, Visual Studio Code, Sublime Text, and so on can also be used in place of the React code to develop the talking avatar application 122.

To enable the rapid creation of these applications, the talking avatar generation system 100 maintains a plurality of templates for talking avatar applications 122 stored in a template database 124, which is operatively coupled to the code generator 114.

These templates serve as predefined blueprints that include common structures, layouts, and functionalities required for avatar-based applications. By storing a variety of templates, the talking avatar generation system 100 allows users to quickly generate applications with respect to different needs and scenarios without starting from scratch. These stored templates can be reused or customized for future operations, significantly reducing the time and effort required to develop new applications.

The code generator 114 is configured to access and utilize a templates database, which includes these predefined templates along with code snippets that implement specific avatar functionalities, such as facial expressions, lip-syncing, and behavior patterns. When a user inputs their specifications, the code generator 114 efficiently combines the relevant templates and code snippets to produce a comprehensive application code that meets the user's requirements. This approach not only speeds up the development process but also ensures consistency and reliability in the generated applications.

In operation 208, an avatar generator 116 creates a personality of the avatar. The personality is defined by using prompt engineering techniques, enabling the avatar to exhibit distinct behaviors, emotional expressions, and conversational traits

The avatar generation is performed using the avatar generator 116 and is provided to the talking avatar application 122 via., an avatar generation API 120, which involves several advanced techniques to create lifelike and responsive avatars. The avatar generator 116 uses 3D rendering to create a detailed 3D model of the avatar. This model forms the foundation of the avatar, providing a structural framework that defines its shape, proportions, and overall appearance.

Next, audio synthesis is used to generate text-to-speech (TTS) audio that is perfectly synchronized with the avatar's lip movements. This ensures that the avatar can communicate in a natural and human-like manner, with its speech closely matching the movement of its lips. The synchronization is achieved by carefully timing the generated audio with the animation of the avatar's mouth, creating a seamless auditory and visual experience.

Blend shape animation is then applied to manipulate the avatar's facial expressions. This technique uses precomputed frames and blends shapes to animate the avatar's face in real-time, allowing for the expression of a wide range of emotions, such as happiness, sadness, anger, or surprise. Additionally, face reenactment is used to enhance the avatar's facial animations and expressions by applying AI-generated 2D image bases. This allows realistic reenactment of facial movements and expressions by overlaying AI-generated details onto the 3D model.

The AI engine 106 further includes a code synthesis algorithm that plays a vital role in translating user specifications into executable application code. This algorithm converts the interpreted avatar specifications derived from the user's natural language input 104 into code that can be run within the application. The code synthesis algorithm also ensures that the generated code accurately defines the behavior, interactions, and visual aspects of the avatar, as specified by the user. This guarantees that the final application meets the user's expectations in terms of functionality and appearance.

The generation of avatars with multi-language capabilities through the avatar generation API 120 allows the avatars to communicate in various languages as specified by the user. The avatar generation API 120 not only translates the verbal content into the desired language but also makes necessary adjustments in the avatar's behavior, tone, and cultural expressions to ensure that the communication is contextually appropriate and culturally sensitive. For instance, an avatar speaking Japanese might adopt a more formal tone and exhibit gestures and expressions that align with Japanese cultural norms, enhancing the user's sense of engagement and authenticity.

In operation 210, a code tester 118 tests the application code in an automated testing environment configured to simulate real-world application usage, and identify and resolve any errors.

After the code generator 114 produces the application code, the user has the option to copy this code directly. This feature allows users, particularly those with some level of coding knowledge, to take the generated React code and implement it within their development environments. The code generator 114 is operatively coupled to the code tester 118. Code testing refers to running each line of code with a controlled input, and verifying if it performs the expected output. The goal is to identify bugs or errors in the codes and correct them to generate the actual application needed by the user. There are three types of testing performed by the code tester 118, namely, unit testing, integration testing, and end-to-end testing.

Unit Testing is the process of testing individual units of code, such as functions or classes. For instance, in React, the common pattern is to divide the UI into smaller parts called Sections, namely, boilerplate, jigsaw pieces, and context.

Integration Testing refers to a type of software testing that focuses on verifying the interactions and communication between different components, modules, or subsystems of a software system. It aims to ensure that the integrated components work together as expected and that the overall system functions correctly. The primary goal of this type of testing is to identify defects or issues that may arise when different components are combined and interact with each other. By testing the integration points and data flow between components, Integration Testing helps uncover errors such as incompatible interfaces, incorrect data transfer, communication failure, and so on.

End-to-end Testing verifies that the application is working correctly from the beginning to the end of a particular user flow. It replicates expected user behavior and various usage scenarios to ensure that your application works as a whole. It uses a production-equivalent environment, as well as, data to simulate real-world situations, and may also involve the integrations your software has with external applications. For instance, ‘Is the button disabled after the X action?’, ‘Does the avatar mute after X time?’, and so on. The End-to-end Testing can be performed at various levels, including, component integration testing, API integration testing, database integration testing, and system integration testing.

In operation 212, the talking avatar application 122 is deployed to a user environment by displaying the talking avatar application 122 to the user, thereby allowing the generated avatar to engage in real-time communication with the user.

After the testing of the application code by the code tester 118, the talking avatar application is generated. Once the talking avatar application 122 is deployed, it enables real-time interaction between the user and the generated avatar. This real-time interaction is characterized by the avatar's ability to communicate using natural language, responding instantly to user inputs with dynamic behaviors and expressions. The talking avatar application 122 is presented to the user in a visually engaging manner on a user device 102, featuring the avatar with whom the user can interact in real-time. The user device 102 may include any device like tablet, computer, laptop, or any other device compatible enough to run such codes and display the talking avatar application 122.

The pseudo-code for the talking avatar application generation system 100 featuring one or more avatars is given below:

```
def create_application_from_natural_language(input_text):
  interpreted_commands = NLP_algorithm(input_text)
  executable_code =
  code_generation_algorithm(interinterpreted_commands)
  test_results = test_generated_code(executable_code)
  if test_results.passed:
    deploy_application(executable_code)
  else:
    raise Exception(“Code Error”)
```

The talking avatar application generation system 100 featuring one or more avatars further includes a feedback collection mechanism that actively gathers user feedback on the avatar's performance and interactions. This feedback is crucial as it provides insights into how well the avatar meets the user's expectations in terms of behavior, emotional expressions, and overall user experience. The collected feedback is then used to re-train the machine learning model, such as a Large Language Model (LLM), allowing the AI engine 106 to continually improve the accuracy and effectiveness of future application generations. This feedback collection enhances the personalization of avatars by refining their ability to respond to user inputs more naturally and in alignment with user preferences.

In an embodiment, the talking avatar generation system 100 can generate applications across various domains. It can generate a talking avatar application, such as a virtual assistant, a gaming application where avatars play roles within interactive stories or games like flashcards, minesweeper, an educational application designed to teach or tutor users more interactively and engagingly like a debate session between two or more avatars on any educational topic, or a business application where avatars might act as customer service agents or virtual sales representatives. The ability to adapt the avatar to these diverse applications showcases the flexibility and wide-ranging utility of the system, making it a powerful tool for developers across multiple industries.

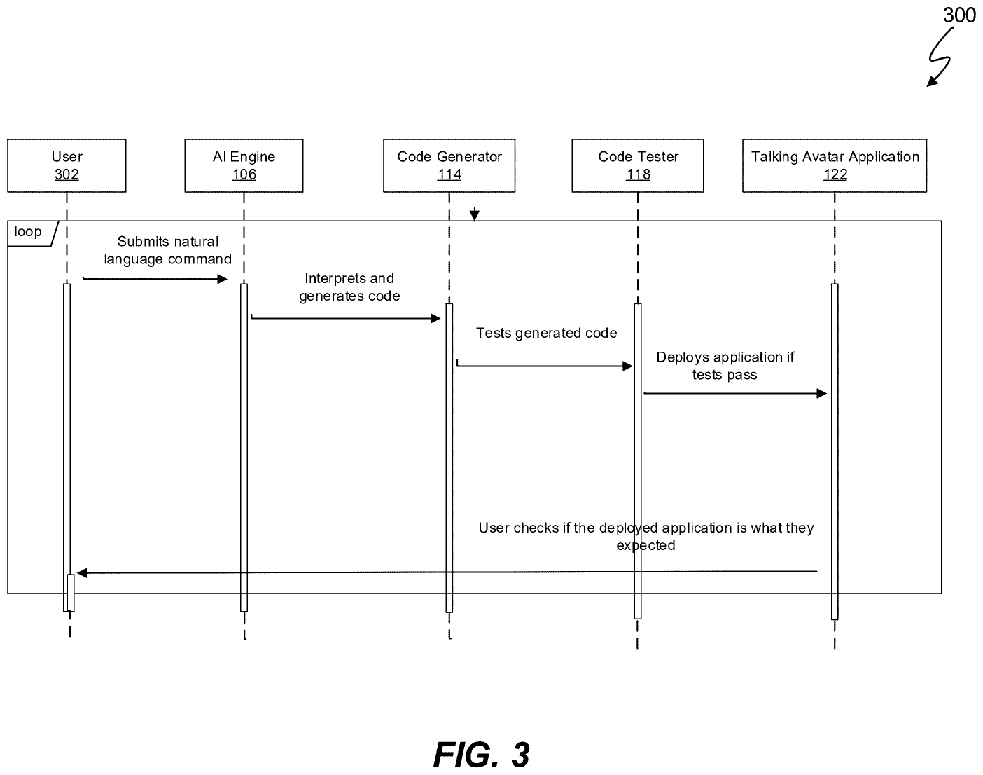

FIG. 3 depicts an application testing and deploying process 300 by utilizing user inputs, which is an embodiment of the talking avatar application generation process 200 featuring one or more interactive avatars, using a natural language input 104.

The application testing and deploying process 300 illustrates the steps of how a user interacts with an AI engine 106 to create, test, and deploy a customized talking avatar application 122 using natural language input 104 or prompt. The application testing and deploying process 300 begins when the user submits a natural language input 104 or prompt to the AI engine 106 via., the chatbot 108. The natural language input 104 or prompt illustrates the desired features and functionalities of the avatar in the talking avatar application 122. The analyzer 110 analyzes the natural language input 104 or prompt, understands the user's intent, and translates it into structured API requests with specific parameters that can be processed further.

These structured API requests are then passed to the code generator 114, which generates the application code based on the user's specifications. The code generator utilizes predefined templates, libraries, and code snippets to efficiently produce the required code. Once the code is generated, it is forwarded to the code tester 118. The testing phase is crucial as it ensures that the code functions as needed. The code tester 118 automates this testing method to clear all the bugs and errors.

If the code passes the tests, the talking avatar application 122 is generated and deployed in the user's environment.

it is sent to the Deployer, responsible for deploying the application in the user's environment. This deployment makes the talking avatar application 122 live, allowing users to interact with the avatar in real-time. The user can then check the deployed application to ensure it meets their expectations. If the application functions as intended, the application testing and deploying process 300 is complete. However, if adjustments are needed, the user can provide additional feedback, and the AI engine 106 can make the necessary modifications.

The above application testing and deploying process 300 will be clearer from the following example. For instance, if a small business owner wants to add a customer support avatar to their e-commerce application, they can input a natural language input 104 or prompt describing the desired functionality. The analyzer 110 interprets the natural language input 104 or prompt, and the code generator 114 produces the necessary code, which is then tested and deployed to the application. The owner can interact with the avatar, and the application testing and deploying process 300 is complete if it meets their expectations. If not, the natural language input 104 or prompt can be adjusted based on the owner's feedback.

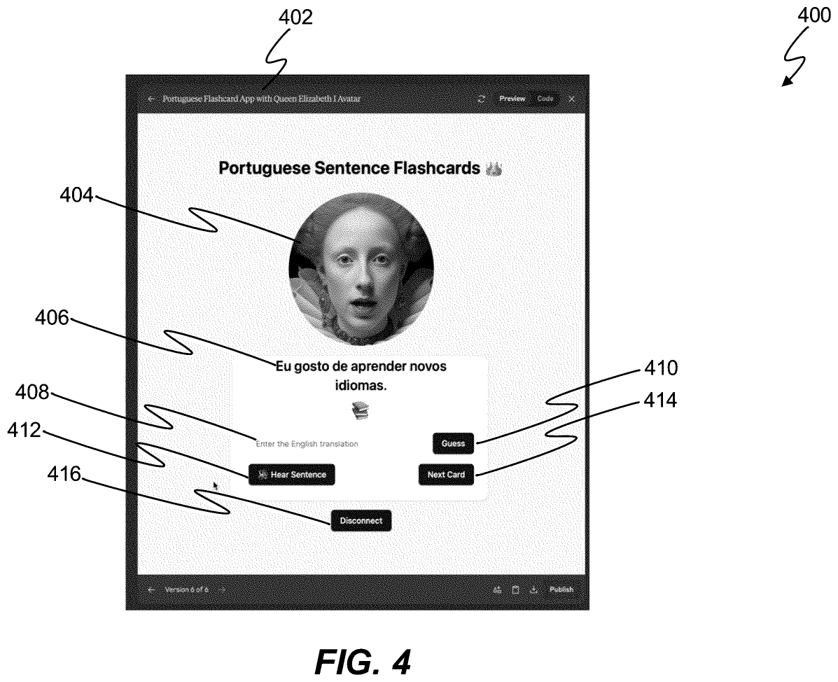

FIG. 4 depicts an exemplary generated application 400 displaying a talking avatar 404.

The generated application 400 displayed in FIG. 4 is a ‘Portuguese Flashcard App With Queen Elizabeth I Avatar’ and the talking avatar 404 is ‘Queen Elizabeth I’. The user provides a natural language input 104 or prompt ‘Create a react app with the avatar sdk that using Queen Elizabeth teaches Portuguese nouns through flashcards and emojis. Make sure to switch the language dialect for the multilingual voice depending on them speaking Portuguese or English. Make sure to include a button for “Say” that prompts the avatar to speak the current flash card.’ to the AI engine 106 via., the chatbot 108. Along with this natural language input 104 or prompt, a SDK code is also provided by the user, which is in the form of a file and is uploaded to the chatbot 108 of the AI engine 106.

Upon receiving the natural language input 104 or prompt and SDK code from the user, the details are analyzed using the analyzer 110. The analyzed insights are then provided to the code generator 114. The application code generated by the code generator 114 is the React code. The AI engine 106 also generates a message in response to the user's input.

An exemplary NLP user input message and the React code generated by the code generator 114 to generate the ‘Portuguese Flashcard App with Queen Elizabeth I Avatar’ is given below. Using the following exemplary user natural language input 104 after the AI Engine 106 has been prompted with the Instruction File:
exemplary user natural language input 104:
Create a react app with the avatar sdk that using Queen Elizabeth teaches Portuguese nouns through flashcards and emojis. Make sure to switch the language dialect for the multilingual voice depending on them speaking Portuguese or English.
Make sure to include a button for “Say” that prompts the avatar to speak the current flash card.
The AI engine 106 can respond with the following message:

Certainly! I'll create a React application that uses the Avatar SDK to have
Queen Elizabeth teach Portuguese nouns through flashcards and emojis.
The application will include a “Say” button to prompt the avatar to speak
the current flashcard, and it will switch the language dialect for the
multilingual voice depending on whether Portuguese or English is being
spoken.

Below is complete, exemplary React application code in a single file with exemplary comments:

```
‘‘‘jsx
// **COMMENT START** High-level goal: Single-file React app that uses an
Avatar SDK to have a “Queen Elizabeth I” avatar teach Portuguese nouns with
flashcards and TTS. Includes connect/disconnect, media rendering, flashcard
navigation, and dual-language “Say” behavior. **COMMENT END**
import React, { useState, useEffect, useRef } from ‘react’;
// **COMMENT START** UI components from shaden. NOTE: In prior guidance, only
shadcn is allowed and lucide-react was forbidden; this code imports lucide
icons below-flagging for awareness. **COMMENT END**
import { Card, CardContent } from ‘@/components/ui/card’;
import { Button } from ‘@/components/ui/button’;
// **COMMENT START** Icon imports (from lucide-react). If your project's
rules forbid lucide-react, replace with text labels or shadcn-compatible
icons. **COMMENT END**
import { ArrowRight, ArrowLeft, VolumeUp } from ‘lucide-react’;
// **COMMENT START** Flashcard data model: each card has a Portuguese word,
its English translation, and an emoji token. Note these emoji strings are
Slack-style (″:dog:″), not Unicode-rendering will show the raw text unless
converted. **COMMENT END**
const flashcards = [
  { portuguese: ‘Cachorro’, english: ‘Dog’, emoji: ‘:dog:’ },
  { portuguese: ‘Gato’, english: ‘Cat’, emoji: ‘:cat:’ },
  { portuguese: ‘Pássaro’, english: ‘Bird’, emoji: ‘:bird:’ },
  { portuguese: ‘Peixe’, english: ‘Fish’, emoji: ‘:tropical_fish:’ },
  { portuguese: ‘Árvore’, english: ‘Tree’, emoji: ‘:deciduous_tree:’ },
];
const PortugueseFlashcardApp = ( ) => {
  // **COMMENT START** sdkIsLoaded gates UI behavior until the external SDK
script finishes loading. **COMMENT END**
  const [sdkIsLoaded, setSdkIsLoaded] = useState(false);
  // **COMMENT START** avatarClient holds the initialized SDK client used for
connect/say/switchAvatar/etc. **COMMENT END**
  const [avatarClient, setAvatarClient] = useState(null);
  // **COMMENT START** room represents the active media/data session with the
avatar; used to attach audio/video tracks. **COMMENT END**
  const [room, setRoom] = useState(null);
  // **COMMENT START** currentCardIndex tracks which flashcard is displayed.
**COMMENT END**
  const [currentCardIndex, setCurrentCardIndex] = useState(0);
  // **COMMENT START** showTranslation toggles visibility of the English
translation text. **COMMENT END**
  const [showTranslation, setShowTranslation] = useState(false);
  // **COMMENT START** Refs used for attaching video and audio tracks
provided by the SDK. **COMMENT END**
  const videoRef = useRef(null);
  const audioRef = useRef(null);
  useEffect(( ) => {
    // **COMMENT START** Dynamically inject the Avatar SDK script. On load,
flip sdkIsLoaded=true; on error, throw to surface failure. **COMMENT END**
    const script = document.createElement (‘script’);
    script.src = ‘https://unpkg.com/alpha-ai-avatar-sdk-js@0.0.1/index.js';
    script.async = true;
    script.onload = ( ) => setSdkIsLoaded(true);
    script.onerror = (err) => {
      // **COMMENT START** NOTE: new Error typically accepts a single message
string; passing (msg, err) won't attach the original error. Consider
console.error + throw new Error(msg). **COMMENT END**
      throw new Error(‘Failed to load Alpha AI Avatar SDK. ’, err);
    };
    document.body.appendChild(script);
    return ( ) => {
      // **COMMENT START** Cleanup: remove script tag on unmount. **COMMENT
END**
      document.body.removeChild(script);
    };
  }, [ ]);
  useEffect(( ) => {
    // **COMMENT START** Once the SDK is loaded, initialize an AvatarClient
and store it in state. **COMMENT END**
    if (sdkIsLoaded && window.Avatar) {
      const client = new window.Avatar.AvatarClient({
        apiKey: ‘s76hu0jzWThfnscn’, // **COMMENT START** WARNING:
Avoid hardcoding API keys in client code; use server-side tokens or env-
injected runtime configs. **COMMENT END**
        baseUrl: ‘https://avatar.alpha.school’
      });
      setAvatarClient(client);
    }
  }, [sdkIsLoaded]);
  useEffect(( ) => {
    // **COMMENT START** When a room exists, subscribe to media track events
to attach/detach audio/video to DOM elements. **COMMENT END**
    if (room && window.Avatar) {
      room
        .on(window.Avatar.RoomEvent.TrackSubscribed, (track) => {
          // **COMMENT START** Attach incoming media tracks to <video> or
<audio> accordingly so the avatar is visible/audible. **COMMENT END**
          if (track.kind == ‘video’) {
            track.attach(videoRef.current);
          } else if (track.kind === ‘audio’) {
            track.attach(audioRef.current);
          }
        })
        .on(window.Avatar.RoomEvent.TrackUnsubscribed, (track) => {
          // **COMMENT START** Detach when tracks are removed to prevent
dangling media streams. **COMMENT END**
          track.detach( );
        });
    }
  }, [room]);
  const connectAvatarRoom = async ( ) => {
    // **COMMENT START** Connect to the default avatar to create a Room; then
switch to avatar ID 29 (intended “Queen Elizabeth I”). **COMMENT END**
    if (avatarClient) {
      const newRoom = await avatarClient.connect( );
      setRoom(newRoom);
      await avatarClient.switchAvatar(29); // **COMMENT START** Switches the
active avatar. Ensure 29 exists and is licensed/appropriate for your use.
**COMMENT END**
    }
  };
  const handleDisconnect = ( ) => {
    // **COMMENT START** Explicitly end the session and clear room state so
UI returns to pre-connection state. **COMMENT END**
    if (avatarClient) {
      avatarClient.disconnect( );
      setRoom(null);
    }
  };
  const handleNextCard = ( ) => {
    // **COMMENT START** Advance to the next flashcard, wrapping around at
the end; hide translation on card change. **COMMENT END**
    setCurrentCardIndex((prevIndex) => (prevIndex + 1) % flashcards.length);
    setShowTranslation(false);
  };
  const handlePreviousCard = ( ) => {
    // **COMMENT START** Go back one card, wrapping to the last when at the
first; hide translation on card change. **COMMENT END**
    setCurrentCardIndex((prevIndex) => (prevIndex − 1 + flashcards.length) %
flashcards.length);
    setShowTranslation(false);
  };
  const handleSayWord = ( ) => {
    // **COMMENT START** Triggers the avatar to speak the current word twice:
first in Portuguese, then in English, using a multilingual voice and setting
dialect via multilingualLang. **COMMENT END**
    if (avatarClient) {
      const currentCard = flashcards[currentCardIndex];
      const portugueseText = ‘A palavra em português é:
${currentCard.portuguese }‘;
      const englishText = ‘The word in English is: ${currentCard.english}‘;
      // **COMMENT START** First utterance in Portuguese. Voice is “en-US-
AvaMultilingualNeural” but dialect hint is pt-PT; verify your engine supports
this voice name + multilingualLang combo. **COMMENT END**
      avatarClient.say(portugueseText, {
        voiceName: ‘en-US-AvaMultilingualNeural’,
        multilingualLang: ‘pt-PT’,
      });
      // **COMMENT START** Second utterance in English (UK). Back-to-back
say( ) calls may queue or interrupt depending on SDK behavior; consider
awaiting completion events if overlap occurs. **COMMENT END**
      avatarClient.say(englishText, {
        voiceName: ‘en-US-AvaMultilingualNeural’,
        multilingualLang: ‘en-GB’,
      });
    }
  };
  if (!sdkIsLoaded) {
    // **COMMENT START** Basic loading gate; nothing in the app renders until
the SDK script is ready. **COMMENT END**
    return <div>Loading Alpha AI Avatar SDK...</div>;
  }
  return (
    // **COMMENT START** Main UI: connect/disconnect controls, media preview
(video/audio), flashcard display, navigation, translation toggle, and “Say
Word”. **COMMENT END**
    <div className=“flex flex-col items-center justify-center min-h-screen
bg-gray-100 p-4″>
      <h1 className=“text-3xl font-bold mb-6”>Learn Portuguese with Queen
Elizabeth I</h1>
      {!room ? (
        // **COMMENT START** When not connected, show a single button to
initialize the room and switch avatar. **COMMENT END**
        <Button onClick={connectAvatarRoom} className=“mb-4″>
          Connect to Avatar
        </Button>
      ) : (
        < >
          {/* **COMMENT START** Video element displays avatar video track;
audio element plays avatar TTS. Audio is visually hidden but autoplay
enabled. **COMMENT END** */}
          <div className=“mb-4 w-full max-w-md”>
            <video ref={videoRef} autoPlay playsInline muted className=“w-
full h-64 bg-gray-200 rounded” />
            <audio ref={audioRef} autoPlay style={{ display: ‘none’ }} />
          </div>
          {/* **COMMENT START** Flashcard UI: large emoji area, Portuguese
term, optional English translation on toggle. **COMMENT END** */}
          <Card className=“w-full max-w-md mb-4”>
            <CardContent className=“flex flex-col items-center p-6″>
              <div className=“text-6xl mb-
4”>flashcards[currentCardIndex].emoji}</div>
              <div className=“text-3xl font-bold mb-
2″>{flashcards[currentCardIndex].portuguese}</div>
              {showTranslation && (
                <div className=“text-xl text-gray-
600”>{flashcards[currentCardIndex].english}</div>
              )}
            </CardContent>
          </Card>
          {/* **COMMENT START** Navigation and translation controls. Consider
disabling Previous/Next while the avatar is speaking to avoid overlapping
utterances. **COMMENT END** */}
          <div className=“flex justify-between w-full max-w-md mb-4″>
            <Button onClick={handlePreviousCard}>
              <ArrowLeft className=“mr-2” /> Previous
            </Button>
            <Button onClick={( ) => setShowTranslation(!showTranslation)}>
              {showTranslation ? ‘Hide’ : ‘Show’} Translation
            </Button>
            <Button onClick={handleNextCard}>
              Next <ArrowRight className=“ml-2″ />
            </Button>
          </div>
          {/* **COMMENT START** TTS trigger: makes the avatar speak both
languages for the current card. **COMMENT END** */}
          <Button onClick={handleSayWord} className=“mb-4”>
            <VolumeUp className=“mr-2″ /> Say Word
          </Button>
          {/* **COMMENT START** Disconnect cleanly closes the room and
returns UI to initial state. **COMMENT END** */}
          <Button onClick={handleDisconnect } variant=“secondary”>
            Disconnect
          </Button>
        </>
      )}
    </div>
  );
};
export default PortugueseFlashcardApp;
```

After the React code is generated, the code tester 118 tests the application code and checks for any errors or bugs in the code. The errors and bugs in the application code, if any, are changed accordingly, in order to avoid any errors in the development of the application 400.

Upon testing the application, the ‘Portuguese Flashcard App With Queen Elizabeth I Avatar’ 400 is generated and deployed in a user-friendly environment and is further displayed to the user on the user's device 102. The generated ‘Portuguese Flashcard App With Queen Elizabeth I Avatar’ 400 includes an image of the talking avatar 404 i.e., ‘Queen Elizabeth I’ in the case of the present example. The generated ‘Portuguese Flashcard App With Queen Elizabeth I Avatar’ 400 also includes ‘Portuguese Sentence’ 406. The user can enter the English translation of the ‘Portuguese Sentence’ 406 in the ‘Enter the English Translation’ tab 408 if they know the answer or else can click on the tab ‘Guess’ 410 to make a guess. The user can also hear the sentence using the ‘Hear Sentence’ tab 412. The user can click on the tab ‘Next Card’ 414 to go to the next card. Further, if the user wishes to exit the ‘Portuguese Flashcard App With Queen Elizabeth I Avatar’ 400, the user can click on the tab ‘Disconnect’ 416.

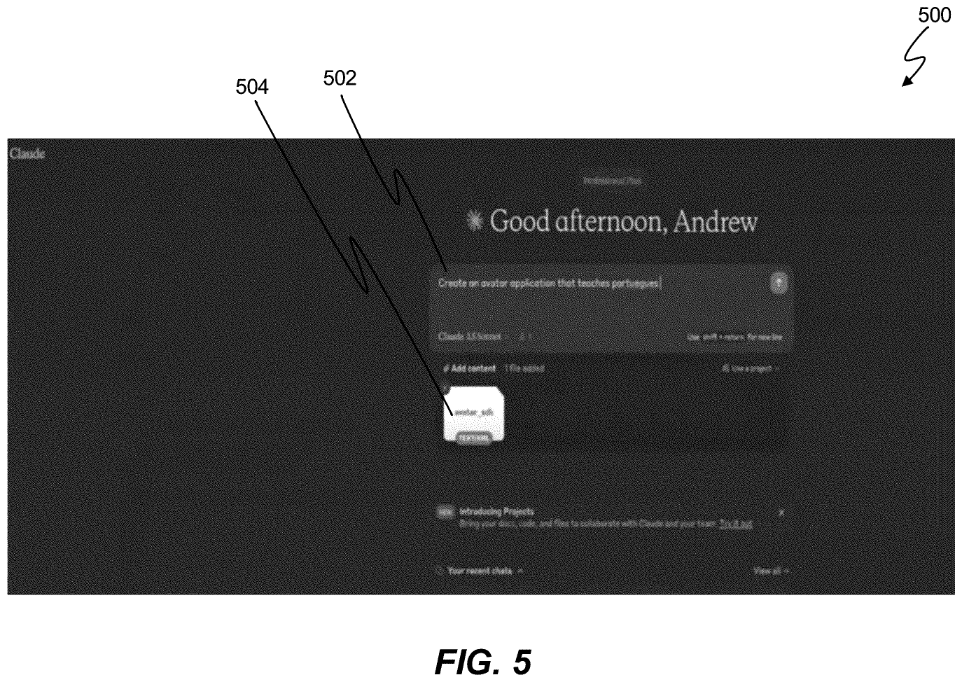

FIG. 5 depicts an AI engine 500 where the user provides the natural language input 104, to guide the AI engine 500 to generate an application code for the generation of a tracking avatar application 122.

The AI engine 500 disclosed in FIG. 5 is ‘Claude’. Claude is a chatbot and language model developed by Anthropic that uses artificial intelligence (AI) to have human-like conversations with users and produce text content. Although the AI engine 500 is not limited to Claude, other AI engines can also be used for application development, like ChatGPT, Gemini, Microsoft CoPilot, and so on.

In the case of the present example, the AI engine 500 includes mainly two blocks, namely, first block 502 to enter the text, and second block 504 to upload the files or documents. The user enters the text input in the first block 502, for instance, in the case of the present example, the user enters ‘Create an avatar application who teaches Portuguese with talking avatars and flashcards’, and in the second block 504, the user uploads the SDK code i.e., the natural language input 104.

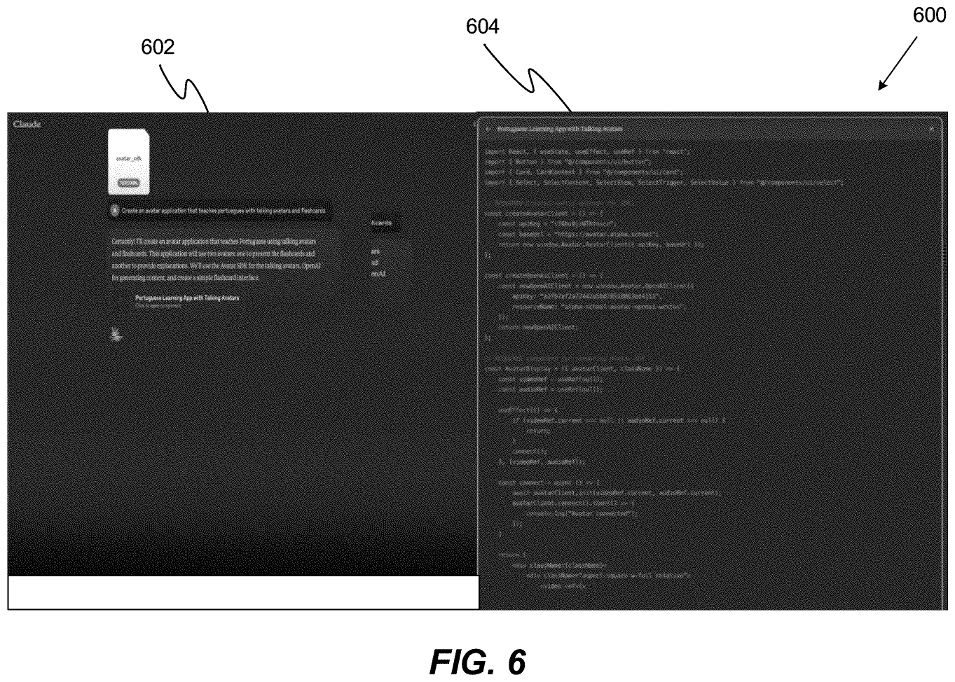

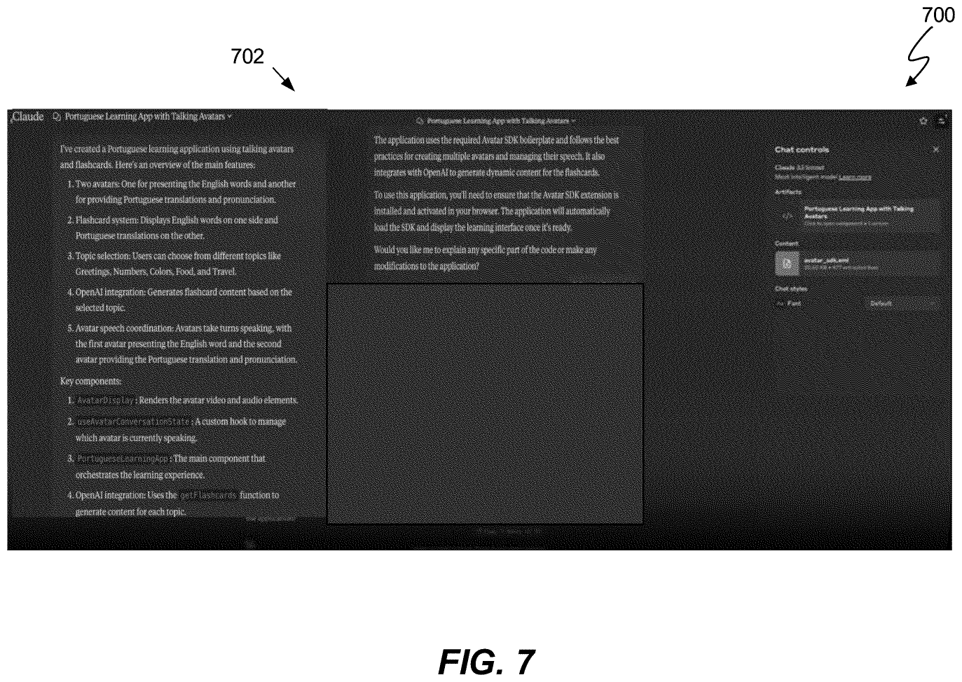

FIGS. 6 and 7 depict exemplary AI engine screenshots where the generated application code and the basic explanation of the application code are shown respectively.

Upon entering the text and the natural language input in the AI engine 500, the user input is analyzed using the analyzed and the analyzed data is fed to the code generator 114. The code generator 114 generator generates the application code, which is a React code 604. Along with the application code, a message 602 is also generated by the AI engine 500. For instance, message 602 in the case of the present example includes ‘Certainly!! I will create an avatar application that teaches Portuguese using talking avatars and flashcards. This application will use two avatars: one to present the flashcards and another to provide explanations. We will use the avatar SDK for the talking avatars, Open AI, for generating content, and creating a simple flashcard interface.’

Based on the generated React code 604, the application will be generated. The React code 604 includes the details of the avatar, i.e., how the avatar should interact, the avatar's emotions, behavior, and so on, and details of the application generation, i.e., how the user wants the application to look.

Upon generation of the React code 604, a message 702 is displayed to a user/developer which includes the overview and components of the generated application. The overview of the generated application involves the basic details about the generated application. The overview includes details of the avatars, flashcard system, topic selection, Open AI integration, and avatar speech coordination.

The components include the basic components that are included in making the application. For instance, in the case of the present example, the components include ‘Avatar Display’ to render the avatar video and audio elements, ‘Avatar Conversation State’ to manage which avatar is currently speaking, ‘Portuguese Learning App’ that orchestrates the learning experience, and ‘Flashcards’ that uses Open AI integration to generate content for each topic.

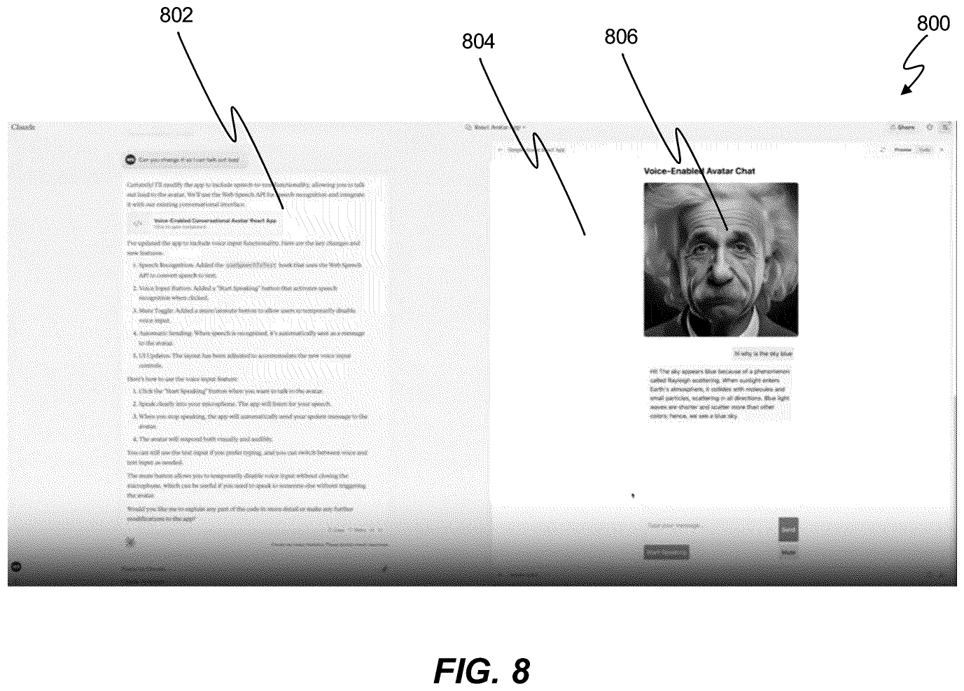

FIG. 8 depicts the exemplary generated talking avatar application 800 featuring an avatar 806, based on the natural language input 104 provided by the user. By establishing the integration of an interactive avatar with natural language recognition and use

The generated talking avatar application 800 featuring an avatar 806 is presented to the user. Since this application includes only text based input so the user provides the input to the AI engine 106 via., the chatbot 108. The input provided by the user includes ‘Can you please change it to audio format as well so that I can speak out loud’.

The AI engine 106 analyzes the natural language input 104 provided by the user and generates a message and an updated talking avatar application 800 featuring an avatar 806 which can interact with the user. The user can interact with the avatar 806 using both text, and speech. The message includes modified features of the talking avatar application 800.

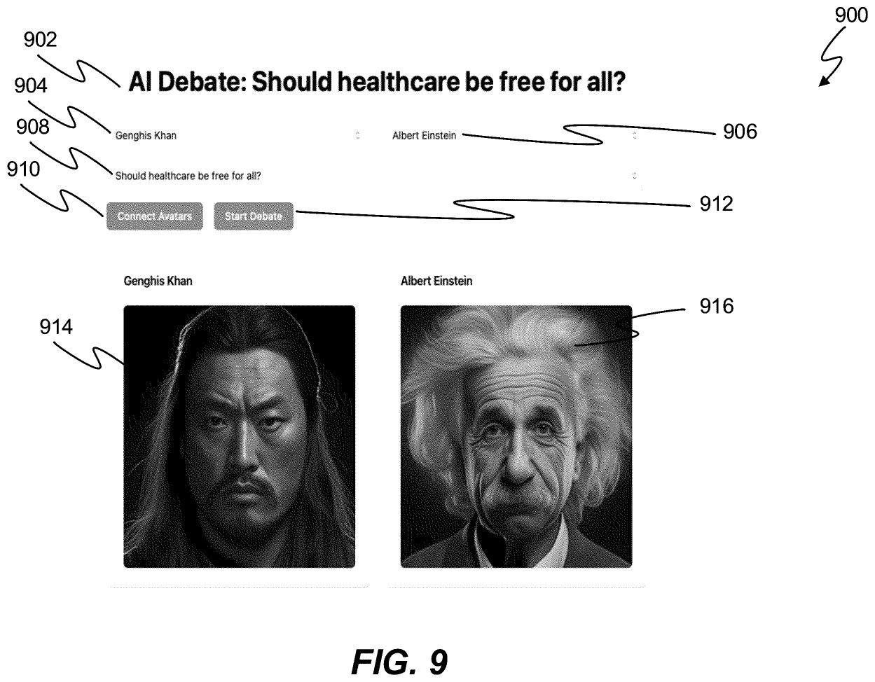

FIG. 9 depicts an exemplary generated talking avatar application 900 that shows two different avatars doing debate and providing their views on a topic.

FIG. 9 shows the gaming application 900 which includes two avatars debating with each other on a topic 902 selected by the user. The topic 902 in the case of the present example includes ‘AI Debate: Should Healthcare Be Free For All?’, which can be selected by the user by clicking on the drop-down menu 908. Further, the user can also select the avatars who will debate from the drop-down menu 904 and 906. After the selection has been made by the user, the avatars 914 and 916 selected from the drop-down menu 904 and 906 appear on the application 900. For instance, in the present example, the avatars are ‘Genghis Khan’ 914 and ‘Albert Einstein’ 916.

The user can click on the tab ‘Connect Avatars’ 910 to establish a connection between the avatars 914 and 916. The user can further start the debate between both the avatars 914 and 916 on the selected topic 902 by clicking on the tab ‘Start Debate’ 912.

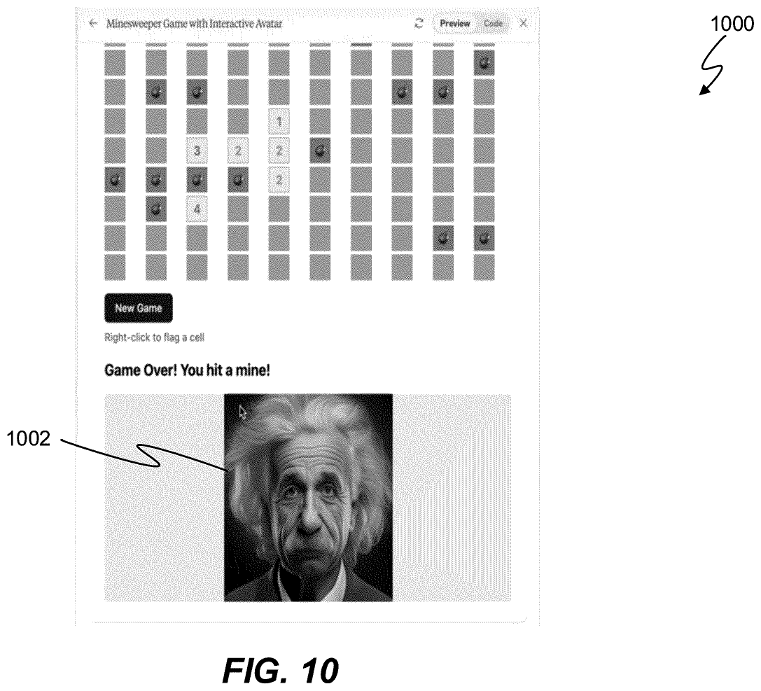

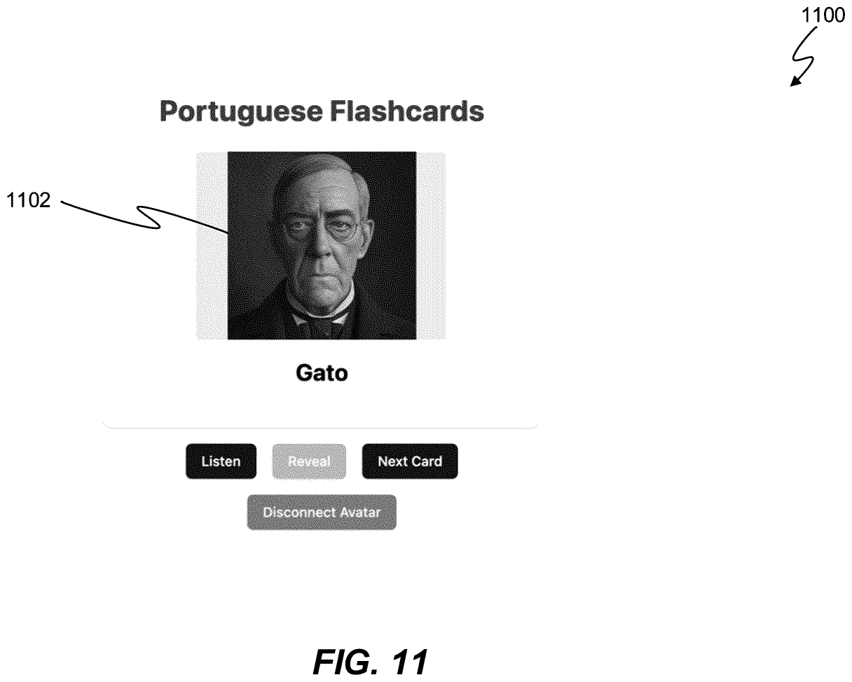

FIGS. 10 and 11 depict exemplary different gaming applications generated by utilizing the talking avatar application generation system 100 featuring one or more interactive avatars.

FIG. 10 shows the gaming application 1000 generated by the user disclosing a minesweeper gaming application 1000 and includes ‘Albert Einstein’ as an avatar 1002.

FIG. 11 shows the gaming application 110 generated by the user disclosing a flashcard gaming application 1100 for learning different languages and includes a talking avatar 1102.

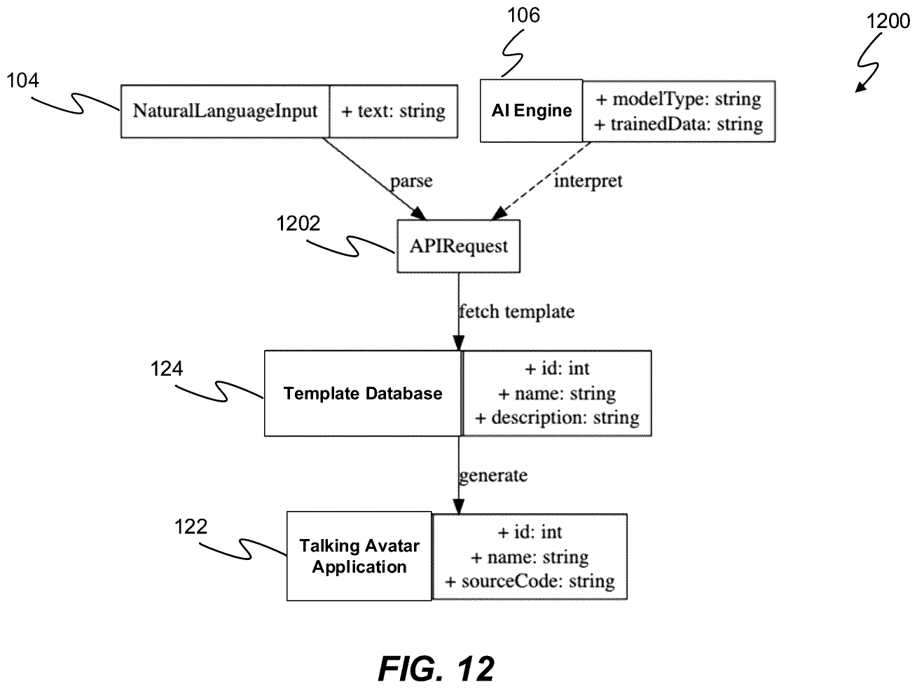

FIG. 12 depicts a data structure 1200 for organizing data to disclose the use of natural language input 104 to generate a talking avatar application 122.

The data structure 1200 represents a sequence of interconnected nodes that work together to generate talking avatar applications 122 based on user-provided natural language input 104. These nodes include NaturalLanguageInput node 104, AIEngine node 106, APIRequest node 1202, TemplateDatabase node 1204, and TrackingAvatarApplication node 122.

The NaturalLanguageInput node 104 captures the prompt entered by the user. This input could include specific instructions, rules, and requirements for the application to be generated, such as the desired functionalities, behaviors, or avatar interactions. Once the natural language input 104 is received, it is parsed and transformed into the APIRequest 1202. This transformation is crucial because the APIRequest node 1202 provides a more formalized and machine-readable format that can be easily interpreted. The APIRequest node 1202 includes a command that tells what action needs to be performed, and a set of parameters that provide additional details or constraints for that command.

The APIRequest node 1202 then interacts with the TemplateDatabase node 124 which stores predefined templates that serve as blueprints for different types of applications. Each template is characterized by an ID, a name, and a description, which collectively define what the template can do. When the system fetches a template based on the APIRequest node 1202, it selects the most appropriate blueprint that matches the user's input.

Next, the selected template is used to create the TrackingAvatarApplication node 122 which represents the final application generated by the talking avatar generation system 100 featuring one or more avatars using the natural language input 104. Throughout the talking avatar generation process 200, the AIModel node 106 plays a crucial role. The AIModel 106 is responsible for interpreting the natural language input 104 and guiding the conversion of this input into the structured APIRequest 1202.

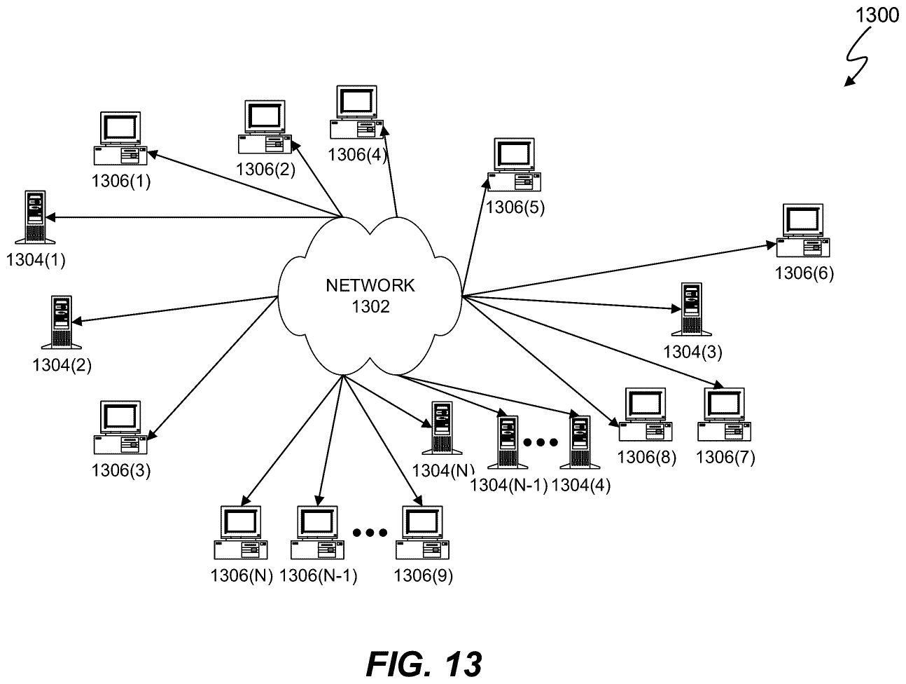

FIG. 13 is a block diagram illustrating a network environment in which a talking avatar application generation system 100 and process 200 featuring one or more interactive avatars, using a natural language input 104 may be practiced. Network 1302 (e.g. a private wide area network (WAN) or the Internet) includes several networked server computer systems 1304(1)-(N) that are accessible by client computer systems 1306(1)-(N), where N is the number of server computer systems connected to the network. Communication between client computer systems 1306(1)-(N) and server computer systems 1304(1)-(N) typically occurs over a network, such as a public switched telephone network over asynchronous digital subscriber line (ADSL) telephone lines or high-bandwidth trunks, for example, communications channels providing T1 or OC3 service. Client computer systems 1306(1)-(N) typically access server computer systems 1304(1)-(N) through a service provider, such as an internet service provider (“ISP”) by executing application-specific software, commonly referred to as a browser, on one of client computer systems 1306(1)-(N).

Client computer systems 1306(1)-(N) and server computer systems 1304(1)-(N) are specialized computers programmed to improve conventional computer systems to implement and utilize the talking avatar application generation system 100 and process 200 featuring one or more interactive avatars, using a natural language input 104. The type of computer system that can be specially programmed to implement and utilize the talking avatar application generation system 100 and process 200 featuring one or more interactive avatars, using a natural language input 104 includes a mainframe, a mini-computer, a personal computer system including notebook computers, a wireless, mobile computing device (including personal digital assistants, smartphones, and tablet computers). These computer systems are typically designed to provide computing power to one or more users locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the talking avatar application generation system 100 and process 200 featuring one or more interactive avatars, using a natural language input 104 can be implemented using code stored in a tangible, non-transient computer-readable medium and executed by one or more processors. In at least one embodiment, the talking avatar application generation system 100 and process 200 featuring one or more interactive avatars, using a natural language input 104 can be implemented completely in hardware using, for example, logic circuits and other circuits including field programmable gate arrays.

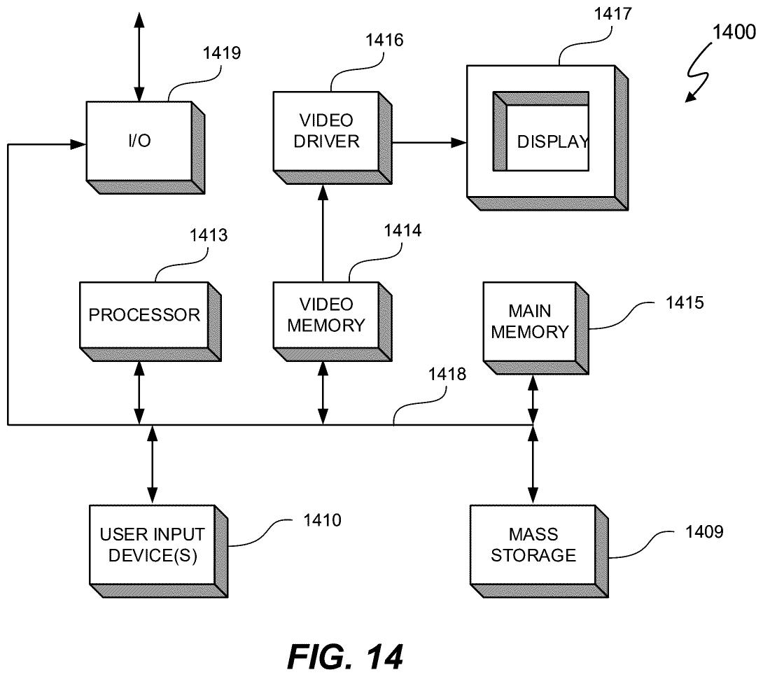

Embodiments of the talking avatar application generation system 100 and process 200 featuring one or more interactive avatars, using a natural language input 104 can be implemented on a computer system such as a special-purpose, special-programmed computer 1400 illustrated in FIG. 14. Input user device(s) 1410, such as a keyboard and/or mouse, are coupled to a bi-directional system bus 1418. The input user device(s) 1410 are for introducing user input to the computer system and communicating that user input to processor 1413. The computer system of FIG. 14 generally also includes a non-transitory video memory 1414, non-transitory main memory 1415, and non-transitory mass storage 1409, all coupled to bi-directional system bus 1418 along with input user device(s) 1410 and processor 1413. The mass storage 1409 may include fixed and removable media, such as a hard drive, one or more CDs or DVDs, solid state memory including flash memory, and other available mass storage technology. Bus 1418 may contain, for example, 32 of 64 address lines for addressing video memory 1414 or main memory 1415. The system bus 1418 also includes, for example, an n-bit data bus for transferring DATA between and among the components, such as CPU 1409, main memory 1415, video memory 1414, and mass storage 1409, where “n” is, for example, 32 or 64. Alternatively, multiplex data/address lines may be used instead of separate data and address lines.

I/O device(s) 1419 may provide connections to peripheral devices, such as a printer, and may also provide a direct connection to a remote server computer system via a telephone link or to the Internet via an ISP. I/O device(s) 1419 may also include a network interface device to provide a direct connection to a remote server computer system via a direct network link to the Internet via a POP (point of presence). Such connection may be made using, for example, wireless techniques, including digital cellular telephone connection, Cellular Digital Packet Data (CDPD) connection, digital satellite data connection, or the like. Examples of I/O devices include modems, sound and video devices, and specialized communication devices such as the aforementioned network interface.

Computer programs and data are generally stored as code in a non-transient computer-readable medium such as flash memory, optical memory, magnetic memory, compact disks, digital versatile disks, and any other type of memory. The computer program is loaded from a memory, such as mass storage 1409, into main memory 1415 for execution. “Memory” can be a single memory component or a collection of multiple memory components. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 1413, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 1415 consists of dynamic random access memory (DRAM). Video memory 1414 is a dual-ported video random access memory. One port of the video memory 1414 is coupled to the video amplifier 1416. The video amplifier 1416 is used to drive the display 1417. Video amplifier 1416 is well-known in the art and may be implemented by any suitable means. This circuitry converts pixel DATA stored in video memory 1414 to a raster signal suitable for use by display 1417. Display 1417 is a type of monitor suitable for displaying graphic images. In at least one embodiment, the computer 1400 includes or is coupled to a natural language processor 1420 and language models 1422.

The computer system described above is for purposes of example only. The talking avatar application generation system 100 and process 200 featuring one or more interactive avatars, using a natural language input 104 may be implemented in any type of computer system programming or processing environment. It is contemplated that the talking avatar application generation system 100 and process 200 featuring one or more interactive avatars, using a natural language input 104 might be run on a stand-alone computer system, such as the one described above. The talking avatar application generation system 100 and process 200 featuring one or more interactive avatars, using a natural language input 104 might also be run from a server computer systems system that can be accessed by a plurality of client computer systems interconnected over an intranet network. Finally, the talking avatar application generation system 100 and process 200 featuring one or more interactive avatars, using a natural language input 104 may be run from a server computer system that is accessible to clients over the Internet.

Although embodiments have been described in detail, it should be understood that various changes, substitutions, and alterations can be made herein without departing from the spirit and scope of the invention as defined by the appended claims.

What is claimed is:

1. A method of guiding an artificial intelligence (AI) engine for generating talking avatar applications featuring interacting one or more avatars using natural language input by a user, the method comprises:
executing code using one or more processors of a computer system to cause the computer system to perform operations comprising:
instruct an AI engine to receive the natural language input from the user and interactively respond to the natural language input;
receiving the natural language input from the user, wherein the natural language input is a prompt provided by the user which includes the context, rules, and guidelines for creating the talking avatar application featuring one or more avatars;
analyzing and parsing the received prompt, wherein the analysis includes converting the prompt into a structured API request that includes a command and associated parameters;
generating application code by utilizing the generated command, wherein the application code integrates the interactive avatar and the associated functionalities specified by the user;
enabling the avatar to exhibit distinct behaviors, emotional expressions, and conversational traits;
testing the generated application code in an automated testing environment configured to simulate real-world application usage, identify and resolve any errors;
deploying the generated talking avatar application to a user environment by displaying the talking avatar application to the user, allowing the generated avatar to engage in real-time communication.

2. The method of claim 1 wherein the prompt provided by the user to the AI engine guides the AI engine in generating the application code.

3. The method of claim 1 wherein the natural language input is provided by the user to the AI engine is a SDK (Software Development Kit) code.

4. The method of claim 1 wherein the prompt analysis is done using LLM further comprises:
utilizing NLP (Natural Language Processing) techniques to parse and interpret the input to identify key elements related to avatar behavior, emotions, and expressions;
extracting relevant information from the prompt to accurately determine the user's intent;
generating avatar specifications based on the understood context and requirements of the user's command.

5. The method of claim 1 wherein the LLM is trained on diverse datasets, including programming languages, application logic, and user interaction with the avatar.

6. The method of claim 1 wherein the associated parameters generated after the analysis of the prompt include expression, behavior, lip-syncing, and eye movement.

7. The method of claim 1 wherein the avatar generation using an avatar generation API further comprises:
3D rendering to create a 3D model of the avatar;
audio synthesis for generating text-to-speech audio synchronized with the avatar's lip movements;
blend shape animation to manipulate the avatar's facial expressions using precomputed frames and blend shapes, ensuring real-time performance;
face reenactment to apply AI-generated 2D image bases to the avatar, enhancing facial animations and expressions.

8. The method of claim 1 wherein the associated functionalities specified by the user include precomputed frames, blend shapes for facial animations, and synchronization with text-to-speech audio, pitch range, emotions, and view angle.

9. The method of claim 1 wherein a code synthesis algorithm is integrated within the AI engine to:
converting the interpreted avatar specifications into executable application code;
utilizing predefined libraries and templates available within the avatar generation API to generate application code;
ensuring that the generated application code accurately defines the behavior, interactions, and visual aspects of the avatar as specified by the user;
generating the interactive applications automatically based on the user's natural language input.

10. The method of claim 1 wherein the application code generated by the AI engine to generate the talking avatar application is a React code.

11. The method of claim 1 wherein the avatar generation API supports multi-language capabilities, allowing the avatar to communicate in different languages as specified by the user, with corresponding adjustments in behavior, tone, and cultural expressions.

12. The method of claim 1 wherein the talking avatar application, upon deployment, enables real-time interaction with the generated avatar, which communicates using natural language and exhibits dynamic behaviors and expressions as defined by the user's input.

13. The method of claim 1 wherein a plurality of templates of the talking avatar applications is stored that can be generated by the user which is further utilized for future operations.

14. The method of claim 1 further comprises:
feedback collection that gathers user feedback on the avatar's performance and interactions, which is used to re-train the LLM, thereby improving future application generations and enhancing the personalization of avatars.

15. A system to guide an artificial intelligence (AI) engine for generating talking avatar applications featuring interacting one or more avatars using natural language input by a user comprises:
one or more processors of a computer system;
a memory, operatively coupled to the one or more processors, storing code that when executed by the one or more processors cause the computer system to perform operations comprising:
instructing an AI engine to receive the natural language input from the user and interactively respond to the natural language input;
receiving the natural language input from the user via. a chatbot integrated within the AI engine, wherein the natural language input is a prompt provided by the user that includes the context, rules, and guidelines for creating the talking avatar application featuring one or more avatars;
analyzing and parsing the received prompt using an analyzer, wherein the analysis involves converting the prompt into a structured API request that includes a command and associated parameters;
generating an application code using a code generator by utilizing the generated command, wherein the application code integrates the interactive avatar and the associated functionalities specified by the user;
enabling the avatar to exhibit distinct behaviors, emotional expressions, and conversational traits;
testing the generated application code using a code tester in an automated testing environment configured to simulate real-world application usage, identify and resolve any errors;
deploying the talking avatar application to a user environment by displaying the talking avatar application to the user, thereby allowing the generated avatar to engage in real-time communication with the user.

16. The system of claim 15 wherein the talking avatar application is displayed to the user featuring the avatar with whom the user can interact in real-time.

17. The system of claim 15 wherein the structured API request generated by the analyzer includes parameters for avatar attributes such as facial expressions, lip-syncing, eye movement, emotional states, and behavior patterns.

18. The system of claim 15 wherein the code generator module is configured to access and utilize a templates database including templates of the plurality of applications and code snippets, facilitating rapid generation of application code that incorporates the specified avatar functionalities.

19. The system of claim 15 wherein the user can copy the application code generated by the code generator to generate the talking avatar application.

20.

21. The system of claim 15 wherein the talking avatar application may include an application featuring a talking avatar, a gaming application, an educational application, an application of business, and so on.
